(19) United States
(12) Patent Application Publication
(10) Pub. No.: US 2019/0307147 A1
(43) Pub. Date: Oct. 10, 2019

(54) METHOD FOR PREPARING AN ICED TEA OR COFFEE BEVERAGE

(71) Applicant: Koninklijke Douwe Egberts B.V., Utrecht (NL)

(72) Inventors: Hendrik Johan Dees, Utrecht (NL); Myrto Dimoula, Banbury (GB); Daniel Thomas Ahearn, St Ives (GB); James Simon Oliver, St Ives (GB); Simon Philip Jelley, St Ives (GB); Finbarr Charles Ronald Williamson, London (GB)

(21) Appl. No.: 16/470,175

(22) PCT Filed: Dec. 27, 2017
(86) PCT No.: PCT/EP2017/084673

§ 371 Date: Jun. 14, 2019

(30) Foreign Application Priority Data
Dec. 28, 2016 (GB) 1622310.9

(51) Int. Cl. A23G 9/04; A23F 5/24; A23F 3/16

(52) U.S. Cl. CPC A23G 9/045; A23F 3/163; A23F 5/243

(57) ABSTRACT

The present invention provides a method for preparing an ice-containing tea or coffee beverage, the method comprising: (i) providing a beverage liquor containing soluble tea or coffee solids, and a freezing-point suppressant; (ii) aerating the beverage liquor by the addition of a gas; (iii) flowing the aerated beverage liquor through a refrigeration system to cool the aerated beverage liquor and to thereby form a plurality of ice crystals within the aerated beverage liquor; and (iv) dispensing the cooled aerated beverage liquor as an ice-containing tea or coffee beverage.

This disclosure relates to iced coffee and tea beverages, a method for making the beverages and an apparatus for use in the method. In particular, the disclosure relates to an aerated ice beverage with a creamy mouthfeel and a long stability once prepared.

It is well known to provide consumers with ice in their beverages to provide greater refreshment. Beyond simply adding ice-cubes, it is well known to provide beverages such as Slush-Puppie® style drinks made by constantly agitating a strongly refrigerated beverage concentrate. Such scraped beverages contain small rough ice fragments and have a slurry-like mouthfeel for the consumer.

Alternatively, beverages may be produced by blending ice cubes with a beverage liquor to produce a beverage with ice flakes distributed therein. This relies on a high speed blender having cutting blades. An example of such beverages based primarily on coffee beverages are so-called Frappuccinos®. While such iced beverages are prepared with a pleasant appearance, they typically melt quickly when provided to the consumer and there is a consequent formation of a watery layer from the melted ice which is devoid of the flavouring present in the rest of the beverage. Furthermore, even when freshly prepared, the ice flakes are visible as agglomerates and are discernible to the consumer on drinking the beverage.

GB2513971 discloses an apparatus for generating a slush containing frozen and non-frozen liquid. The slush is made from a draught beverage, such as beer, lager or cider. Similarly US2001/0041210 relates to an apparatus for the production of beverage liquids containing slush ice.

U.S. Pat. No. 3,823,571 discloses a machine for dispensing a semi-frozen carbonated beverage, and particularly such a machine including a system for automatically controlling the quality of the beverage through various timed modes.

EP0745329 discloses a carbonated coffee beverage which has been packaged under pressure in a pressure-resistant closed container, which beverage is based on coffee extract, the coffee beverage having been packaged in the closed container in the presence of CO2 and nitrogen, which beverage preferably contains sugar and/or sweetener.

Accordingly, there is a desire for an alternative format of iced coffee and tea beverage, preferably with a smoother, creamier mouthfeel and a greater stability and/or a method for preparing a beverage which tackles at least some of the problems associated with the prior art or, at least, provides a commercially useful alternative thereto.

According to a first aspect there is provided a method for preparing an ice-containing tea or coffee beverage, the method comprising:
(i) providing a beverage liquor containing soluble tea or coffee solids, and a freezing-point suppressant;
(ii) aerating the beverage liquor by the addition of a gas;
(iii) flowing the aerated, preferably sweetened, beverage liquor through a refrigeration system to cool the aerated beverage liquor and to thereby form a plurality of ice crystals within the aerated beverage liquor; and
(iv) dispensing the cooled aerated beverage liquor as an ice-containing tea or coffee beverage.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

While the following description refers primarily to coffee beverages, it should be appreciated that the invention applies equally to tea beverages, i.e. to beverages comprising soluble tea and/or coffee solids.

The present inventors sought to provide an iced coffee beverage. However, they found that the stability of conventional ice-containing beverages was lacking after the beverage had been formed. Surprisingly they found that an aerated coffee beverage as described herein had significantly increased stability. That is, by providing fine ice crystals and a fine bubble structure, the ice did not agglomerate and form larger clumps, nor did the bubbles break or coalesce. Rather, the ice and bubbles remained well distributed for longer and the ice melted more slowly. A watery layer did not form for a much longer time period than a non-aerated beverage. Furthermore, there was no separation more generally of the beverage into layers for an appreciable time after the beverage was formed (i.e. at least 10 minutes).

Surprisingly the inventors also found that the beverage produced with aeration had a creamy mouthfeel, despite a low amount of dairy ingredient or even no dairy ingredient. In this way the inventors were able to provide a low calorie, low fat beverage with the texture of a creamy luxury beverage recipe.

The present method relates to a method for preparing an ice-containing tea or coffee beverage—a so-called iced tea or iced coffee beverage. Tea and coffee beverages are well-known and comprise dissolved tea and coffee solids. By way of example, a typical coffee beverage might be formed by reconstituting a spray- or freeze-dried coffee powder or by the extraction of roast and ground coffee beans. For the avoidance of doubt, a coffee beverage as defined herein is one produced from any part of the coffee plant, including elements from one or more of the coffee cherry, coffee husk, coffee beans, or coffee plant leaves. Similarly, a tea beverage is one produced from any part of a tea plant, typically an extraction from the leaves. The most preferred beverage is one made from coffee solids, such as are present in a standard coffee beverage, i.e. an espresso or cappuccino. Thus, the most preferred coffee solids are those obtained by extraction of a coffee bean.

According to the method, a beverage liquor is provided containing soluble tea or coffee solids. A beverage liquor as defined herein refers to liquid used in the process to form the beverage. Solids refer to those components of a liquid concentrate which are left behind when all of the water is removed from the concentrate. Thus, for example, an instant soluble coffee powder may be considered the coffee solids of a dehydrated coffee extract. The solids are preferably soluble solids, but may contain small amounts of fine insoluble material.

The beverage liquor contains soluble coffee or tea solids. Preferably the liquor contains 0.5 to 6 wt %, by weight of the total beverage liquor of coffee or tea solids, more preferably from 1 to 5 wt % coffee or tea solids. This level of coffee or tea solids would typically provide a desirable strength of tea or coffee beverage.

The beverage liquor also includes a freezing point suppressant in addition to the tea or coffee solids. As will be appreciated, a freezing point suppressant is an ingredient which reduces the temperature at which a liquid freezes. Generally any soluble ingredient will act to suppress the melting point of water, but the extent to which it affects the melting point will depend on the ingredient itself and the amount which is present.

The importance of the freezing point suppressant in the present invention lies in how it affects the ice-crystal growth. In a pure water/ice slush the ice is not particularly stable and is subject to a ripening process whereby small crystals tend to melt and larger crystals tend to grow. The presence of the freezing point suppressant serves to reduce this Ostwald ripening and allow the preservation of small ice crystals in the slush which is formed. As explained below, the method and apparatus used herein favour the production of fine ice-crystals which are stabilised by the freezing point suppressant.

Preferably the beverage liquor comprises the freezing point suppressant in an amount sufficient to suppress the melting point of the liquor by from 0.2 to 3° C., preferably by from 0.4 to 1° C. This measurement is in comparison to the melting point of ice/water, and is based on the presence of the same concentration of the freezing point suppressant in a water solution. That is, this measurement disregards the presence of the tea and/or coffee solids which will also have a separate suppressing effect on the water. Melting point measurements are well known in the art.

The freezing point suppressant may be any food-safe soluble ingredient such as a salt, an alcohol, a sugar, ice-structuring proteins or combinations of two or more thereof. It is most preferred that the freezing-point suppressant is a sweetener, such as a polyol or a sugar or a mixture thereof.

The most preferred freezing point suppressant is sugar, preferably sucrose. Suitable sugars include mono and disaccharides, preferably, sucrose, fructose, and/or glucose. If a sugar is included which has been separately refined from a coffee or tea material, then this is considered as part of the freezing point suppressant, rather than as part of the tea or coffee solids.

The use of conventional sugars permits the provision of a beverage made from simple, conventional beverage ingredients, such as coffee and sugar, and optionally milk, in a new form with a surprising physical appearance. Where the freezing point suppressant is sugar or another sweetener, the beverage liquor may be considered a sweetened beverage liquor.

Preferably the sweetened beverage liquor comprises 3.2 to 25 wt % sugar, preferably 5 to 8 wt % sugar. Preferably the sugar is sucrose. These amounts of sugar are sufficient to depress the melting point, while also providing a desirable level of sweetness to the final beverage.

The beverage liquor therefore comprises soluble coffee or tea solids and one or more sugars, as well as the water forming the majority of the liquor. The liquor may also include a dairy ingredient, such as milk or cream, preferably in an amount of less than 25 wt %, more preferably less than 10 wt %. The presence of such dairy ingredients in tea and coffee beverages is well known, such as for English breakfast tea, or for Lattes.

However, the presence of fat in the liquor, such as dairy fats from the inclusion of dairy ingredients affects the stability of the bubbles. In addition, the presence of high fat levels caused high viscosity increases during the cooling step, making the liquor difficult to pump and causing difficulty in providing a consistent ice fraction. Accordingly, the sweetened beverage liquor preferably comprises fats in an amount of less than 20 wt %, preferably less than 10 wt % and, preferably is substantially or completely free of fat.

The liquor may further comprise other additives, such as flavourings, stabilisers, hydrocolloids (gums and thickeners), buffers, colouring agents, vitamins and/or minerals, and mouthfeel enhancers, or combinations of two or more thereof. These further additives preferably comprise less than 5 wt % of the liquor, more preferably less than 1 wt % of the liquor. Such additives as gums and thickeners are well-known to help stabilise thicker beverages such as iced coffees, but are considered by consumers to be unhealthy. It was therefore surprising that the beverage produced by the method can be very stable despite the absence of such ingredients.

Most preferably the beverage liquor is free from any such further additives and, therefore, the liquor consists of only tea or coffee solids, a freezing point suppressant such as one or more sugars, and water, and optionally any dairy ingredient. Preferably the beverage liquor is free from any dairy ingredients.

The method comprises several key steps. In a first process step the beverage liquor is aerated by the addition of a gas to form an aerated beverage liquor. By aerated it is meant that a gas is introduced into the liquor to form a foamed structure containing fine bubbles of the gas. Preferably the gas is air or nitrogen, or another food-grade gas. Air is preferred for convenience.

The gas is preferably added in an amount to achieve an overrun in the final beverage of from 10 to 150%, preferably from 20 to 100%, most preferably from 25 to 75%. The inventors found that when the air fraction was too high the foam was too stiff and hard to pump, especially with a diaphragm pump. Conversely a low air fraction settled out more quickly and was less stable. The extent of settling out in the present beverages can be seen as a bubble and ice-free layer on the bottom of the beverage, rather than as a water layer, in view of the homogeneous mixing of ingredients.

Overrun is a standard term in the food and drinks industry to measure the amount of air included in a foamed foodstuff. The overrun may be calculated using the following formula:

Overrun=(volume of foamed beverage−volume of initial liquid)/volume of initial liquid*100

Preferably the step of aerating the beverage liquor involves inline addition of the gas into a flow of the beverage liquor. That is, the gas is added into a duct containing a flow of the beverage liquor, rather than turbulent mixing of the liquor in a container, for example. The flow in such a duct may be driven by a pump from a reservoir to the refrigeration system, or perhaps forced from the reservoir by a pressure of gas. Thus the gas is added before the step of refrigeration which forms the ice fraction.

In order to favour the production of a fine distribution of small bubbles, preferably the inline addition of gas is through a plurality of gas inlet orifices within the duct. Alternatively or in addition, the fine distribution of bubbles can be enhanced by passing the pumped flow of the beverage liquor with the added gas through a static mixer or one or more constricting orifices. The inventors have found that the use of constricting orifices is particularly advantageous because the high pressure jet which is then formed serves to split the bubbles into even finer bubbles which enhance the final beverage creaminess and stability.

By way of example, a 1 mm gas injection orifice might produce 5 mm bubbles in the duct. The passing of these bubbles through an orifice of less than 1 mm fractures these bubbles into bubbles smaller than 1 mm each. This fine bubble structure aids the ice stability and the creaminess of the final beverage.

The gas is preferably added at a pressure of up to 10 Bar, preferably from 3 to 4 Bar. The beverage produced by the present method was found to have a surprisingly constant size of bubbles homogeneously dispersed within the beverage. In particular, the bubbles typically had a size with substantially all of the bubbles ranging from 70 to 140 microns in diameter. In addition, adding the gas under pressure and keeping the liquor under pressure helps to reduce the volume of air which needs to be pumped through the system making the fluid behave less compressibly, which makes the fluid easier to pump.

The second key process step is flowing the aerated beverage liquor through a refrigeration circuit within the refrigeration system to thereby form a plurality of ice crystals within the aerated beverage liquor. A preferred refrigeration circuit is described below and preferably takes the form of the circuit described in either US2001/0041210 or GB2513971.

The refrigeration circuit is used to produce an ice fraction within the beverage liquor. Preferably the ice fraction forms from 10 to 50 wt % of the beverage, preferably from 20 to 30 wt %. This can be measured through the use of a simple cafetiere device used to decant the liquid from the ice-crystals and by determining the relative weights. In practice this may overstate the ice-fraction to a small extent, due to retained water, however, it provides consistently reproduceable and measurable results.

The ice-crystals produced in the method preferably have a size ranging from 0.1 to 1 mm, preferably 0.2 to 0.65 mm. Preferably the mean particle size is about 0.25 mm. The size may be measured on a sample using a microscope to measure the longest diameters of each ice crystal. In contrast, scraped surface heat exchanger ice crystals are typically 2 to 5 mm in size.

Preferably the refrigeration circuit includes a recirculation flow-path. That is, at least a portion of the beverage liquor is cycled around within the refrigeration circuit to provide the ice crystals time to grow and develop. The more developed the ice crystals the more rounded they become, the greater their long term stability and the less prone to agglomeration they become.

Preferably the refrigeration system comprises a plastic duct within which the aerated beverage liquor is pumped. The plastic surface of the duct reduces ice-crystal nucleation on the duct, encouraging the formation of ice crystals within the liquor and reducing the risk of blockage. That is, in a scraped refrigeration device the ice-crystals tend to grow along the cooled surface walls and form plate-like shards. In contrast, the plastic piping encourages dendritic ice crystal growth from the walls into the flowing channel. Such crystals then get broken off quickly into the flow, where the flow and limited Ostwald ripening encourage more rounded development of the crystals: branches are snapped off or melt away. As a result, the ice crystals which form in the refrigeration circuit are smaller and tend to have a tighter, more rounded structure which adds to the longevity of the beverage produced.

Without wishing to be bound by theory it is believed that this smoothening process allows crystals to exist as individual crystals and become dispersed within the beverage. This is in contrast to the small, dendritic crystals produced by the scraped surface machine (typical slush puppy machine) which appear to only survive as large agglomerates of ice crystals.

Preferably the refrigeration circuit comprises a heat exchanger having a first surface in contact with the pumped aerated sweetened beverage liquor and a second surface in contact with a chilled coolant liquid. Preferably the chilled coolant liquid comprises propylene glycol and is at a temperature of from −5° C. to −10° C.

The third key step is dispensing the flow of aerated beverage liquor as an ice-containing tea or coffee beverage. A suitable dispensing nozzle may take the form of a conventional beverage nozzle, such as a post-mix style head for ready provision of the final beverage at a bar or beverage counter.

According to a further aspect there is provided an aerated ice-containing beverage obtainable by the method of any of the preceding claims. The aerated beverage has a discernibly different form to a non-aerated beverage and has a surprisingly long stable time without the formation of a separate water layer.

According to a further aspect there is provided an aerated ice-containing beverage comprising:
(a) 0.5 to 6 wt % soluble tea or coffee solids,
(b) one or more freezing point suppressants, preferably sucrose such as in an amount of from 3.2 to 8 wt %,
(c) less than 10 wt % fats, and
(d) the balance substantially ice and water,
wherein the one or more freezing point suppressants are present in an amount sufficient to suppress the melting point of the water by from 0.2 to 3° C.;
the beverage having an overrun of from 10 to 150%,
the ice having an average ice-crystal size of from 0.1 to 1 mm, and
wherein for at least 10 minutes after production the beverage does not form a distinct non-foamed or non-ice-containing layer.

The beverage discussed in this aspect is preferably made according to the method disclosed herein. Accordingly, all ranges and amounts discussed in the first aspect apply equally this further aspect.

The inventors were surprised to discover that the beverage thus produced was stable for at least 10 minutes and generally up to 30 minutes or more with substantially no significant settling out.

Preferably the aerated ice-containing beverage is free from gums, thickeners and stabilisers.

Preferably the aerated ice-containing beverage consists of 0.5 to 6 wt % soluble tea or coffee solids, 3.2 to 25 wt % sugar, less than 10 wt % fats, and the balance ice and water.

According to a further aspect there is provided an apparatus for preparing an ice-containing tea or coffee beverage, the apparatus comprising:
(i) a source of beverage liquor;
(ii) a refrigeration system comprising a refrigeration circuit in fluid connection with the source of beverage liquor via a supply duct;
(iii) a pump arranged to circulate the beverage within the refrigeration circuit;
(iv) a beverage dispensing outlet for dispensing an ice-containing tea or coffee beverage from the refrigeration circuit into a receptacle; and
(v) a source of pressurised gas arranged to deliver pressurised gas into the supply duct for aerating the beverage liquor.

The source of beverage liquor may take one of several forms. For example, the source may be a simple reservoir for a beverage liquor. That is, a storage vessel within which a concentrate may be made-up by addition of water to form a liquor having a desired level of beverage solids, such as tea and coffee solids and sugar and/or polyols, or alternatively, a storage vessel which comes filled with a ready to use beverage liquor. Alternatively the source may comprise a mixing system, such as a so-called bag-in-box system, whereby a concentrate is diluted on-demand with fresh water to provide the beverage liquor. Alternatively the source may comprise on demand beverage preparation, including tea or coffee extraction and the subsequent addition of water and the freezing-point suppressant.

A refrigeration system including a refrigerant circuit is described in GB2513971 and US20010041210 for fast chilling of a beverage liquor to form an ice slush. The circuit typically involves the use of a coolant liquid and a heat-exchanger.

The refrigeration circuit is in fluid connection with the reservoir via a supply duct. The supply duct provides a conduit between the reservoir and the refrigeration circuit through which the beverage liquor can be pumped. The supply duct preferably comprises one or more static mixing features, such as restrictions or obstacles in the flow-path, or flow restricting orifices, for mixing the liquor, especially after gas has been introduced into the liquor. Most preferred is a single flow-restricting orifice to produce a jet and reduce the entrained bubble size.

A pump is arranged to circulate the beverage within the refrigeration circuit. This pump may be configured to draw the liquid from the source of beverage liquor or this may require an additional pump or source of compressed gas. As will be appreciated, the system will further comprise the necessary control valves to ensure that the flow is as intended.

A beverage dispensing outlet is provided for dispensing an ice-containing tea or coffee beverage from the refrigeration circuit into a receptacle. Suitable outlets include post-mix-style dispensing heads and the like.

The apparatus further comprises a source of pressurised gas arranged to deliver pressurised gas into the supply duct for aerating the beverage liquor. The source of gas is typically a gas cylinder containing air or nitrogen under pressure, or may be a compressor for on-demand supply of pressurised air. The gas is supplied through one or more air inlets within the duct.

A preferred embodiment of the above invention is a method for preparing an ice-containing tea or coffee beverage, the method comprising:
(i) providing a sweetened beverage liquor containing soluble tea or coffee solids;
(ii) aerating the sweetened beverage liquor by the addition of a gas;
(iii) flowing the aerated sweetened beverage liquor through a refrigeration circuit to cool the aerated sweetened beverage and to thereby form a plurality of ice crystals within the aerated sweetened beverage liquor; and
(iv) dispensing the pumped aerated sweetened beverage liquor as an ice-containing tea or coffee beverage.

In this embodiment the final beverage consists essentially of tea and/or coffee solids, one or more sweeteners, ice, water and optionally one or more dairy ingredients.

All weights provided for the ingredients of the beverage liquor are by total weight of the liquor. The balance of the weight will be water.

The invention will now be described in relation to the following non-limiting figures, in which:

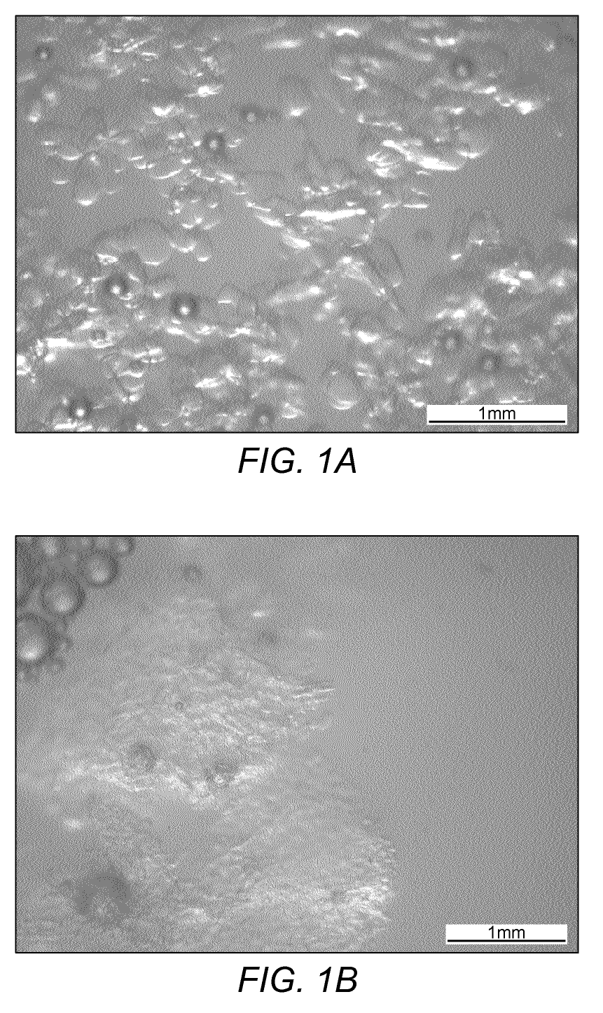

FIG. 1A shows the ice crystals produced according to the method described herein.

FIG. 1B shows the ice crystals produced according to a prior art scraped surface method.

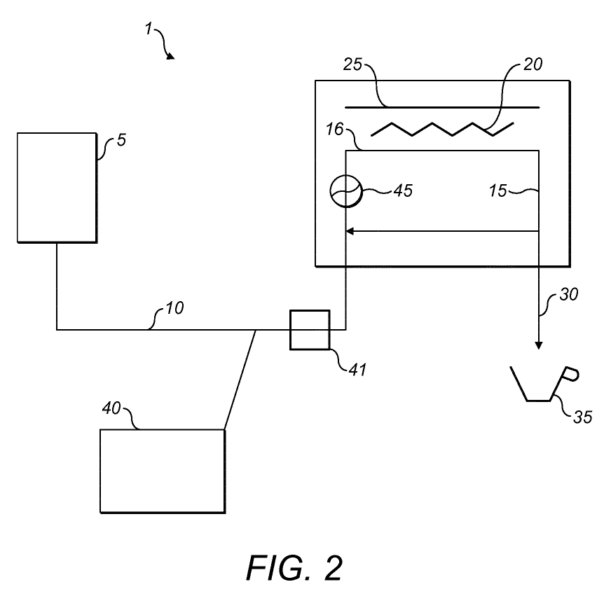

FIG. 2 shows a schematic of the apparatus usable according to the method described herein.

As shown in FIG. 2 there is an apparatus 1 for preparing an ice-containing tea or coffee beverage. The apparatus 1 comprises a reservoir 5 for holding a beverage liquor. The reservoir 5 may have means for stirring or agitating the liquor.

The reservoir 5 is connected via a supply duct 10 to a refrigeration circuit 15. The refrigerant circuit 15 comprises a plastic duct 16 within which the liquor flows, which has a recycle loop to permit the liquor to recirculate within the circuit 15. The refrigeration circuit 15 comprises a heat exchanger 20 for cooling the liquor using pre-chilled refrigerant, such as propylene glycol at a temperature of from −5° C. to −10° C., which is flowed within a separate duct 25.

The refrigeration circuit 15 is also in fluid communication with a dispensing outlet 30 for dispensing an ice-containing tea or coffee beverage from the refrigeration circuit 15 into a receptacle 35.

A source of pressurised gas 40, such as a gas cylinder, is provided to supply pressurised gas into the supply duct 10 for aerating the sweetened beverage liquor. The gas may be supplied through a nozzle having a plurality of inlets to encourage the formation of fine bubbles, but a single nozzle entry will suffice. The gas mixing may also or alternatively involve a static mixer or one or more constricting orifices 41.

A pump 45 is also provided to circulate the sweetened beverage within the refrigeration circuit 15. This is provided within the refrigeration circuit 15, but a further pump may be provided in the supply duct 10.

In use, the apparatus 1 shown in FIG. 2 allows the preparation of an ice-containing tea or coffee beverage. Beverage liquor containing soluble tea or coffee solids and a freezing point suppressant is pumped or driven with pressurised gas from the reservoir 5, through the supply duct 10 to the refrigeration circuit 15. Gas is dosed into the supply duct 10 from the gas source 40 via mixing means 41, such as a through-flow aperture or orifice.

The liquor circulates, driven by the pump 45, within the refrigeration circuit 15 and through the heat exchanger 20, where it is cooled so that ice crystals form slowly. Due to the plastic surface of the duct 16, the ice crystals tend to be small and rounded.

An ice-containing tea or coffee beverage is dispensed on demand from the circuit 15 via the outlet 30 into the beverage receptacle 35. The gas is added to provide an overrun of from 25 to 100%. The added gas is preferably air or nitrogen.

The appearance of the beverage which is produced will depend on the ice-fraction and the overrun of the beverage. A beverage with a high overrun, such as 100% and a low ice-fraction, such as 10 to 20%, will resemble a homogeneous light brown foam and will retain this form and stability for upward of 10 minutes. In practice the ice is well insulated and melts slowly. Eventually an underlying coffee or tea layer may form, but this will typically take at least 30 minutes. No separate water layer will form, as would be seen in a beverage made from coarse ice-crystals. In a beverage with coarser ice-crystals, these typically migrate to the top as they are least dense and then melt without the beverage solids being present.

A beverage with a lower overrun, such as 25% and with a higher ice fraction, such as 30%, may form an initial thicker foam layer on a darker beverage layer. However, the whole structure will have an even distribution of ice and will not form a separate water layer. Instead it may resemble, albeit with less separation, the classic beverage Guinness® appearance of a dark liquor with a foamed head and demonstrates a storm-cloud settling effect. The foam persists in part because it is stabilised by the fine ice-crystals distributed therein.

The invention will now be described in relation to the following non-limiting examples.

An initial beverage liquor was prepared including water, together with re-dissolved freeze dried coffee and granulated sugar (sucrose). The soluble coffee solids were 1.5 wt %. The sugar was in an amount of 8 wt %, which is enough to depress the melting point of water by approximately 0.8° C. No fat-containing ingredients were present.

Food grade nitrogen was added from a compressed gas cylinder at about 4 bar through a single injection needle into the liquid inlet flow at approximately 4 bar. The aerated mixture was mixed through one orifice plate of 1 mm and further mixed in the pump to give an overrun of approx. 100% at atmospheric pressure once dispensed.

The beverage had an ice-fraction of 12% by mass measured using the cafetiere method

When left without disturbance the beverage remained substantially foamed (approx. ¾s of the beverage) and ice remained within the beverage for more than 30 minutes. The beverage has a smooth creamy texture not unlike that found in dairy-product-containing beverages. The ice crystals do not clump and can be drunk through a straw, giving an interesting mouth feel.

As demonstrated in these examples, the claimed method provides a novel beverage for the consumer. In particular, it has the refreshment of a cold beverage without a grainy or rough icey structure. Instead, the fine bubble and ice-crystal structure results in a creamy mouthfeel, despite the absence of dairy fats or the like. Thus, the inventors have been able to provide a healthy ice beverage with a rich texture.

Although preferred embodiments of the invention have been described herein in detail, it will be understood by those skilled in the art that variations may be made thereto without departing from the scope of the invention or of the appended claims.

1. A method for preparing an ice-containing tea or coffee beverage, the method comprising:
(i) providing a beverage liquor containing soluble tea or coffee solids, and a freezing-point suppressant;
(ii) aerating the beverage liquor by the addition of a gas;
(iii) flowing the aerated beverage liquor through a refrigeration system to cool the aerated beverage liquor and to thereby form a plurality of ice crystals within the aerated beverage liquor; and
(iv) dispensing the cooled aerated beverage liquor as an ice-containing tea or coffee beverage.

2. The method of claim 1, wherein the beverage liquor comprises 0.5 to 6 wt % soluble tea or coffee solids.

3. The method of claim 1, wherein the freezing point suppressant is present in an amount sufficient to suppress the melting point of the liquor by from 0.2 to 3° C. compared to water, preferably from 0.2 to 1° C. compared to water.

4. The method of claim 1, wherein the freezing point suppressant is selected from the group consisting of a sweetener, a sugar, a polyol, and mixtures of two or more thereof.

5. The method of claim 1, wherein the beverage liquor comprises 3.2 to 25 wt % sugar, preferably 5 to 8 wt % sugar.

6. The method of claim 1, wherein the beverage liquor comprises fats in an amount of less than 20 wt %, preferably less than 10 wt % and, preferably is free of dairy solids.

7. The method of claim 1, wherein the beverage liquor is free from gums, thickeners and stabilisers.

8. The method of claim 1, wherein the step of aerating the beverage liquor introduces gas in an amount sufficient to achieve an overrun of from 10 to 150%, preferably 25 to 100%.

9. The method of claim 1, wherein the added gas in the step of aerating the beverage liquor is air or nitrogen.

10. The method of claim 1, wherein the step of aerating the beverage liquor involves inline addition of the gas into the flow of the beverage liquor.

11. The method of claim 10, wherein the inline addition of gas is through a plurality of gas inlet orifices.

12. The method of claim 10, wherein the step of aerating the beverage liquor further comprises passing the flow of the beverage liquor with the added gas through a static mixer or one or more constricting orifices.

13. The method of claim 1 wherein the refrigeration system is a refrigeration circuit comprising a recirculation flow-path.

14. The method of claim 1 wherein the refrigeration system comprises a plastic duct within which the aerated beverage liquor is cooled.

15. The method of claim 1 wherein the refrigeration system comprises a heat exchanger having a first surface in contact with the flow of aerated beverage liquor and a second surface in contact with a chilled coolant liquid.

16. The method of claim 15, wherein the chilled coolant liquid comprises propylene glycol and is at a temperature of from −5° C. to −10° C.

17. An aerated ice-containing beverage obtainable by the method of claim 1.

18. An aerated ice-containing beverage comprising:
(a) 0.5 to 6 wt % soluble tea or coffee solids,
(b) one or more freezing point suppressants, preferably sucrose,
(c) less than 10 wt % fats, and
(d) the balance substantially ice and water,
wherein the one or more freezing point suppressants are present in an amount sufficient to suppress the melting point of the water by from 0.2 to 3° C.;
the beverage having an overrun of from 10 to 150%,
the ice having an average ice-crystal size of from 0.1 to 1 mm, and
wherein for at least 10 minutes after production the beverage does not form a distinct non-foamed or non-ice-containing layer.

19. The aerated ice-containing beverage according to claim 18, which is free from gums, thickeners and stabilisers.

20. Apparatus for preparing an ice-containing tea or coffee beverage, the apparatus comprising:
(i) a source of beverage liquor;
(ii) a refrigeration system comprising a refrigeration circuit in fluid connection with the source of beverage liquor via a supply duct;
(iii) a pump arranged to circulate the beverage within the refrigeration circuit;
(iv) a beverage dispensing outlet for dispensing an ice-containing tea or coffee beverage from the refrigeration circuit into a receptacle; and
(v) a source of pressurised gas arranged to deliver pressurised gas into the supply duct for aerating the beverage liquor.
